(19) United States
(12) Patent Application Publication
(10) Pub. No.: US 2018/0308159 A1
(43) Pub. Date: Oct. 25, 2018

(54) SYSTEMS AND METHODS RELATING TO A MARKETPLACE SELLER FUTURE FINANCIAL PERFORMANCE SCORE INDEX

(71) Applicants: Daniel Knijnik, Old Greenwich, CT (US); Anibal Knijnik, Porto Alegre (BR)

(72) Inventors: Daniel Knijnik, Old Greenwich, CT (US); Anibal Knijnik, Porto Alegre (BR)

(73) Assignee: Visinger LLC, Rye Brook, NY (US)

(21) Appl. No.: 15/960,994

(22) Filed: Apr. 24, 2018

Related U.S. Application Data
(60) Provisional application No. 62/489,282, filed on Apr. 24, 2017.

(51) Int. Cl. G06Q 40/02; G06Q 30/02; G06N 99/00; G06N 5/04

(52) U.S. Cl. CPC G06Q 40/025; G06Q 30/0202; G06Q 30/0282; G06N 5/04; G06N 99/005

(57) ABSTRACT

A method, and associated system, for using a financial performance forecast relating to an online marketplace seller, including, under control of one or more processors configured with executable instructions, collecting historical data relating to activities of the online marketplace seller; executing a machine learning component of an adaptive machine learning platform to generate a machine learning component output, where the machine learning component output is generated at least in part based on the historical data; generating, based at least in part on the machine learning component output of the machine learning component, a financial performance forecast score; and making a recommendation to provide funding to the online marketplace seller, based at least in part on the financial performance forecast score.

### CROSS-REFERENCE TO RELATED APPLICATIONS

The present application claims priority to U.S. Provisional Patent Application No. 62/489,282, filed Apr. 24, 2017, the disclosures and teachings of which are incorporated herein by reference.

### TECHNICAL FIELD

The present invention relates to systems and methods for evaluating sellers in an online-based commercial environment to assist sellers, lenders, investors, and/or other financial service providers in making sales-based financial and reliability forecasts.

### BACKGROUND OF THE INVENTION

The retail marketplace is changing quickly, moving from brick and mortar retail companies that typically grow slowly and build financial capabilities along the way to today's agile marketplace-focused sellers, e.g., retail companies that rely on marketplaces like AMAZON, ETSY, EBAY, MERCADO LIBRE, and JET, which are starting to dominate and change the retail business. These marketplace-focused sellers are often lean companies with means for rapid growth. Since the marketplaces are the client owners, this new breed of seller does not need to generate client online traffic, traditionally one of the most significant challenges to e-commerce sales, and can sell almost everything through new channels, such as the online marketplace. As a result, these sellers experience rapid growth rates and possess unimaginable scalability potential. With easy access to millions of clients, the primary constraint on these sellers becomes their ability to finance their growth. Traditional lenders are not able to adequately assist these sellers, as they still rely on standard credit analysis that does not appropriately capture the dynamics of this new market and do not have the proper tools to evaluate credit in this new environment. The combination of limited tools and a lack of expertise has a large impact on credit offerings and drives up the cost of funding available for sellers.

Today's e-commerce companies face a huge challenge in managing the flow of capital, as their financial cycles have become much longer than in the past. With most of their products being produced to order and coming from abroad, particularly China and other Asian countries, it takes as long as 175 days from the time of a down payment to the moment when the revenue is transferred by the marketplace to a company's bank account, as illustrated in Table 1.

TABLE 1

| Description | Length (Days) |
|---|---|
| Order (initial down payment of 20-30%) | Day 1 |
| Goods are received abroad (balance payment of | Day 45 |
| 70-80%) | |
| Logistics Company ships and clears goods to/in | Day 55-85 |
| the US | |
| Shipping and Registration to/on Marketplaces | Day 70-105 |
| Selling Cycle | Day 100-150 |
| Net-Receivables from Marketplaces are credited | Day 120-165 |
| to Seller's account | |

The sourcing location varies significantly based on the nature of the product offered, although China and Southeast Asian countries represent most foreign suppliers. The shipping cycle is also significantly impacted by the location to which products are shipped, e.g., East Coast vs. West Coast of the United States. Online sellers' receivables are usually just 15 days old and are credited on a net basis, after storage, shipping, handling, advertisement, and referral fees are paid to the marketplace.

Lenders are unable to find a way to securitize these receivables, and the above-mentioned fees are difficult to estimate and not adequately understood through traditional credit metrics. Lenders are used to lending money to retailers based on traditional credit metrics represented by gross receivables, predominantly those relating to credit cards. The additional fees and limitations to securitize these types of receivables makes these companies hard to evaluate and nearly non-financeable under current practices of financial markets. Another aspect of the retail marketplace requiring consideration is brand recognition. Traditional retail companies have brands capable of direct valuation. More than 50% of marketplace sales come from private label products, and very few of these sellers can create a valuable brand.

In light of the issues associated with these sellers, there is a need for a mechanism that assists, with a desired level of risk assessment and confidence, both lenders and retailers in financing businesses having the aforementioned marketplace operations.

### SUMMARY OF THE INVENTION

In general, in one aspect, the invention features a method for using a financial performance forecast relating to an online marketplace seller, including, under control of one or more processors configured with executable instructions, collecting historical data relating to activities of the online marketplace seller, where the historical data comprises one or more of a total number of customer reviews over one or more defined time periods and a rating attributed to the online marketplace seller based on the customer reviews over the one or more defined time periods; executing a machine learning component of an adaptive machine learning platform to generate a machine learning component output, where the machine learning component output is generated at least in part based on the historical data; generating, based at least in part on the machine learning component output of the machine learning component, a financial performance forecast score; and making a recommendation to provide funding to the online marketplace seller, based at least in part on the financial performance forecast score.

Implementations of the invention may include one or more of the following features. The recommendation to provide funding may include a funding value and a funding interest rate, and/or may be based on parameters previously defined by a user. The historical data may include one or more of a total number of customer reviews over the previous 30 days, a total number of customer reviews over the previous 90 days, a total number of customer reviews over the previous 365 days, and a total number of customer reviews over the lifetime of the online marketplace seller. The historical data may include one or more of a rating attributed to the online marketplace seller based on the customer reviews over the previous 30 days, a rating attributed to the online marketplace seller based on the customer reviews over the previous 90 days, a rating attributed to the online marketplace seller based on the customer reviews over the previous 365 days, and a rating attributed to the online marketplace seller based on the customer reviews over the lifetime of the online marketplace seller. The historical data may further include one or more of a total number of positive customer reviews over one or more defined time periods, a total duration of the presence of the online marketplace seller in the online marketplace, and a rate of change in quality of customer reviews over one or more defined time periods. The historical data may include one or more of a total number of sold products over one or more defined time periods and prices of the sold products.

The adaptive machine learning platform may utilize a random forest algorithm. The financial performance forecast score may include one or more weighted factors relating to the historical data. The method may further include generating, based at least in part on the financial performance forecast score and one or more of a reliability score and a credit bureau credit score, a hybrid financial performance forecast score, where the reliability score is a predictive value relating to the online marketplace seller being a fraudulent seller. The method may further include receiving new data relating to activities of the online marketplace seller occurring subsequent to the activities represented by the historical data, where the new data comprises one or more of a total number of customer reviews over one or more defined time periods and a rating attributed to the online marketplace seller based on the customer reviews over the one or more defined time periods; executing a second machine learning component of an adaptive machine learning platform to generate a second machine learning component output, where the second machine learning component output is generated at least in part based on the historical data and the new data; and generating, based at least in part on the second machine learning component output of the second machine learning component, an updated financial performance forecast score. The method may further include automatically producing and transmitting a lending proposal to the online marketplace seller, based at least in part on the financial performance forecast score.

In general, in another aspect, the invention features a system configured to use a financial performance forecast relating to an online marketplace seller, including one or more processors, one or more computer-readable media, and one or more modules maintained on the one or more computer-readable media that, when executed by the one or more processors, cause the one or more processors to perform operations including: collecting historical data relating to activities of the online marketplace seller, where the historical data comprises one or more of a total number of customer reviews over one or more defined time periods and a rating attributed to the online marketplace seller based on the customer reviews over the one or more defined time periods; executing a machine learning component of an adaptive machine learning platform to generate a machine learning component output, where the machine learning component output is generated at least in part based on the historical data; generating, based at least in part on the machine learning component output of the machine learning component, a financial performance forecast score; and making a recommendation to provide funding to the online marketplace seller, based at least in part on the financial performance forecast score.

Implementations of the invention may include one or more of the following features. The recommendation to provide funding may include a funding value and a funding interest rate, and/or may be based on parameters previously defined by a user. The historical data may include one or more of a total number of customer reviews over the previous 30 days, a total number of customer reviews over the previous 90 days, a total number of customer reviews over the previous 365 days, and a total number of customer reviews over the lifetime of the online marketplace seller. The historical data may include one or more of a rating attributed to the online marketplace seller based on the customer reviews over the previous 30 days, a rating attributed to the online marketplace seller based on the customer reviews over the previous 90 days, a rating attributed to the online marketplace seller based on the customer reviews over the previous 365 days, and a rating attributed to the online marketplace seller based on the customer reviews over the lifetime of the online marketplace seller. The historical data may further include one or more of a total number of positive customer reviews over one or more defined time periods, a total duration of the presence of the online marketplace seller in the online marketplace, and a rate of change in quality of customer reviews over one or more defined time periods. The historical data may include one or more of a total number of sold products over one or more defined time periods and prices of the sold products.

The adaptive machine learning platform may be configured to utilize a random forest algorithm. The financial performance forecast score may include one or more weighted factors relating to the historical data. The system may further include an additional operation including generating, based at least in part on the financial performance forecast score and one or more of a reliability score and a credit bureau credit score, a hybrid financial performance forecast score, where the reliability score is a predictive value relating to the online marketplace seller being a fraudulent seller. The system may further include additional operations including receiving new data relating to activities of the online marketplace seller occurring subsequent to the activities represented by the historical data, where the new data comprises one or more of a total number of customer reviews over one or more defined time periods and a rating attributed to the online marketplace seller based on the customer reviews over the one or more defined time periods; executing a second machine learning component of an adaptive machine learning platform to generate a second machine learning component output, where the second machine learning component output is generated at least in part based on the historical data and the new data; and generating, based at least in part on the second machine learning component output of the second machine learning component, an updated financial performance forecast score. The system may further include an additional operation including automatically producing and transmitting a lending proposal to the online marketplace seller, based at least in part on the financial performance forecast score.

### BRIEF DESCRIPTION OF THE DRAWINGS

FIG. 1 shows a distribution of the variation in the number of reviews, referred to as slope, which assists in understanding how marketplace sellers behave over time.

FIG. 2 shows a predictive sales plot, where the model predicts whether a marketplace seller will increase or decrease its sales over the next six months.

FIG. 3 shows an example of a prediction of a subsequent month's sales (blue line), where the model estimates the confidence intervals of the prediction (shadowed boundaries).

FIG. 4 shows an output, relating to a marketplace seller, that is provided by a system of the present invention.

FIG. 5 shows a graphical illustration of slope, which is the angular coefficient of the linear predictor for the number of reviews as a function of time (e.g., in months).

FIG. 6 shows a distribution plot relating to the probability of a marketplace seller increasing its number of reviews in the next six months as compared to the number of marketplace sellers with that probability in a given comprehensive dataset. The numbers in the x-axis represent the probability multiplied by 1000. For example, a seller with a calculated performance score (or index) of 890 means that it has an 89% probability of increasing its number of reviews in the next six months. The y-axis represents the number of sellers out of the utilized sample with the same probability.

FIG. 7 shows the influence of variables which may be used in a prediction model for a given marketplace seller. Negative influence values for a variable means an adverse effect on the calculation of the Performance Score. A higher negative value means a smaller Performance Score.

FIG. 8 shows the relative importance of variables used in the Performance Score calculation of one embodiment of the present invention.

FIG. 9 shows growth (positive or negative) for marketplace sellers in the last six months plotted against Performance Score.

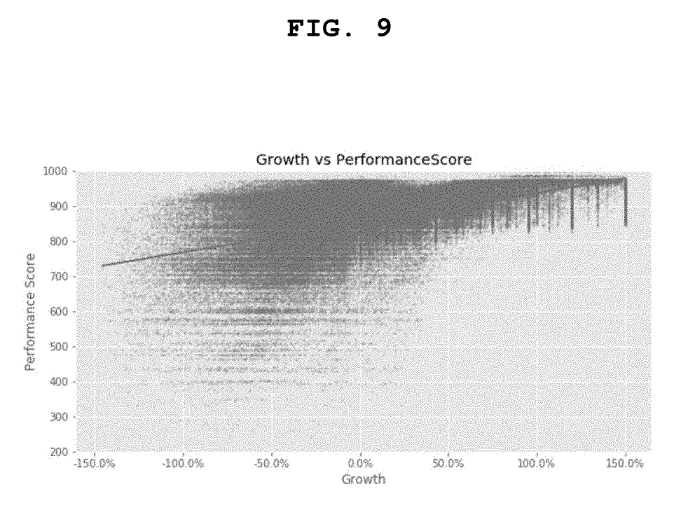

FIG. 10 shows an example of monthly R² statistics of the Performance Score from December 2015 to May 2017. It also shows the number of marketplace sellers and the R² statistics of their Performance Score separated by category: Top Performers, Good Performers, Steady Performers, and Under Performers. R² provides a measure of how well-observed outcomes are replicated by the model, based on the proportion of total variation of results explained by the model. As it can be seen, all R²≥0.80, which attests the good fit of the model to actual data, as a perfect fit will have R²=1.

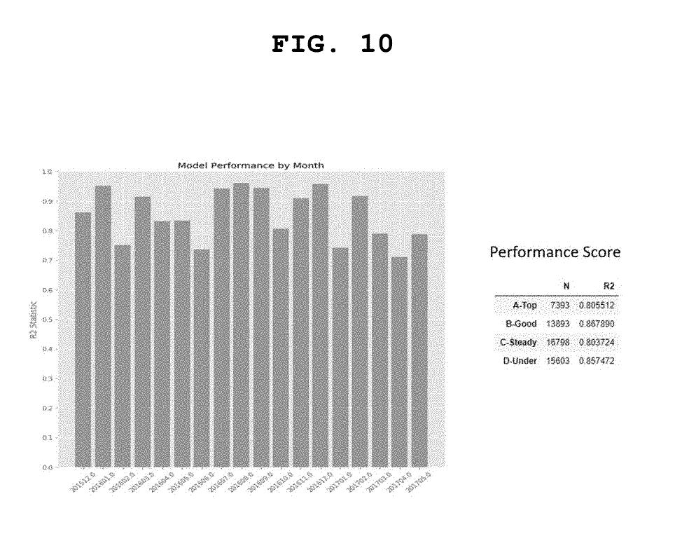

FIG. 11 shows the ROC (Receiving Operating Characteristic) curve, where the AUC (Area under the Curve) is 0.874. It was found that the average error between the actual values and the predicted values is 10.8%.

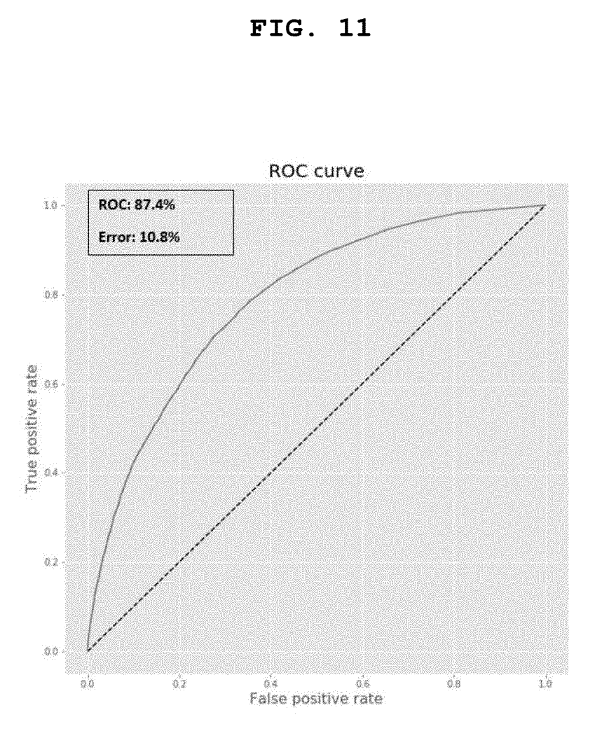

FIG. 12 shows the relative importance of variables used in the Feedback Prediction calculation of one embodiment of the present invention.

FIG. 13 shows the model performance of a 180 days feedback prediction to the actual 180 days feedback count. The blue line is a perfect prediction (R²=1.00). The plot shows an agreement between the predicted values according to the proposed model and the actual behavior of the sellers with an R²=0.8154.

FIG. 14 shows a general overview of a process by which a machine learning model may be created to predict the reliability of a marketplace seller. Reliability is defined to be the tendency that a seller is not a fraud and will exist for at least the next six months.

FIG. 15 shows a sample of typical data collected from public information about sellers, such as number of feedbacks, quality of the feedbacks, offered products, and prices, that may be utilized to determine the reliability of a marketplace seller.

FIG. 16 shows the distribution of a Reliability Score according to one embodiment of the present invention.

FIG. 17 shows the relative importance of variables used in the Reliability Score calculation of one embodiment of the present invention.

### DETAILED DESCRIPTION OF THE INVENTION

Marketplaces typically provide public information about online sellers. For example, UBER provides such information about its drivers, AMAZON about its sellers, and AIRBNB about its hosts. As a result, customers can decide which service provider they will use or which seller they will buy from, based on this clear and objective information. Table 2 provides an example of the public information available for a seller in the AMAZON marketplace. Almost all marketplaces provide this information freely to the public. This public information may include the number of seller reviews (including their quality level, i.e., an alphanumeric rating) received in the last 30 days, 90 days, 12 months (or 365 days), and lifetime in the marketplace. This information is available about all sellers in the AMAZON marketplace.

TABLE 2

| | 30 days | 90 days | 12 months | Lifetime |
|---|---|---|---|---|
| Positive | 99% | 100% | 100% | 99% |
| Neutral | 0% | 0% | 0% | 0% |
| Negative | 1% | 0% | 0% | 1% |
| Count | 12,263 | 39,894 | 159,500 | 630,793 |

Using the information previously described, ratios can be calculated to determine trends on the number of sales, sales amount, and reputational problems, which assist in evaluating the health of a company and the probability that the company is reliable, i.e., does not present an abnormality. The ratio of the number of reviews to the volume of sales has been found to be roughly stable, according to product category and considering that higher quality products generate fewer reviews than poorer quality products, and thus provides an excellent proxy for sales itself.

A deep learning algorithm of the present invention uses historical information about known, non-reliable sellers, such as the number of reviews of the last year, quality (or rating) of the reviews, number of products sold, and prices of the products sold, to identify potential behaviors that assist in checking for discrepancies in the available information. It is possible, based on a proper analysis of the collected data with big data tools utilizing machine learning and benchmark analysis, to predict the likelihood of a seller's consistency and soundness.

The model may also operate as a financial measurement tool alone or as an aid in risk evaluation upon combination with traditional credit metrics sourced by credit bureaus, providing for a more robust analysis. This combination can deliver alternative levels for probabilities of default. For instance, a borrower may apply for a term loan with a traditional financial institution. If the lender relies solely on the owner's personal credit score, the offering will be extremely limited. By incorporating the aforementioned information, the lender has a better understanding of the borrower's, e.g., seller's, future financial performance and soundness, which permits for a better assessment of the risks related to the seller's business. Money managers and investment banks may also use this model to identify retail trends, discover source companies for merger and acquisition activities, or predict sales results to support investment and valuation decisions. Accordingly, the present invention may provide a recommendation to provide funding to the online marketplace seller. This recommendation may include a value and/or an interest rate relating to the funding. Additionally, the recommendation may be predicated on parameters previously defined by a user.

The present invention relies on big data and machine learning software to build its index, and may be based on one or more of the following variables: (i) LTNR: Lifetime number and quality of reviews from a seller; (ii) 30DNR: Last 30 days' number and quality of reviews; (iii) 90DNR: Last 90 days' number and quality of reviews; and (iv) 365DNR: Last 365 days' number and quality of reviews.

The above times (30 days, 90 days, 365 days, and lifetime) are typical times, but the present invention may be utilized with any given set of different times and/or milestones, e.g., 45 days, 120 days, 730 days, last five years, etc. In one embodiment of the present invention, the time intervals and/or milestones are 30 days, 90 days, 365 days, and lifetime.

With the aforementioned variables, the present invention may calculate the following ratios, among others, where X may assume the values “C” for “Count,” “R” for “Reviews,” “P” for “Positive Reviews,” “N” for “Neutral Reviews,” and “B” for “Bad Reviews”: (i) 30LTX: Ratio Between 30DNR/LTNR; (ii) 3090DNRX: Ratio Between 30DNR/90DNR; (iii) 30365DNRX: Ratio Between 30DNR/365DNR; (iv) 90365DNRX: Ratio Between 90DNR/365DNR; (v) 90LTNRX: Ratio Between 90DNR/LTNR; and (vi) 365LNRX: Ratio Between 365DNR/LTNR.

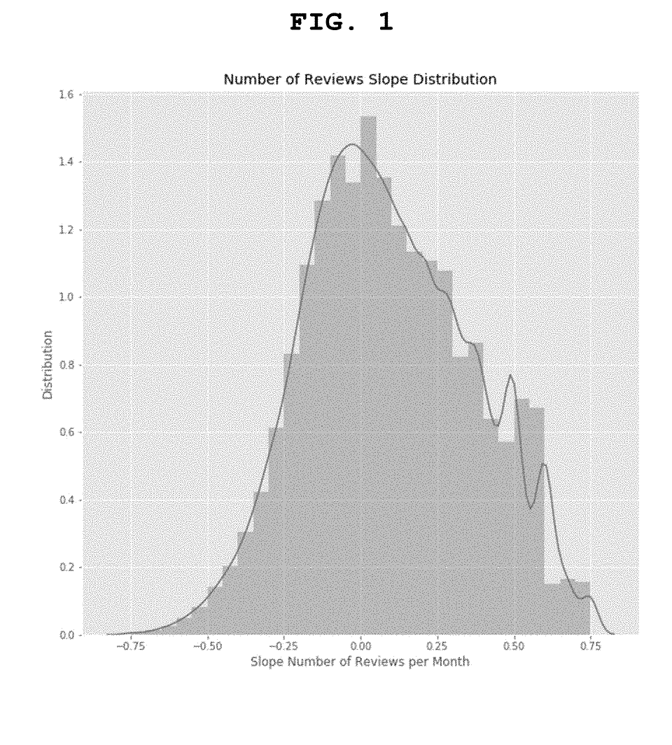

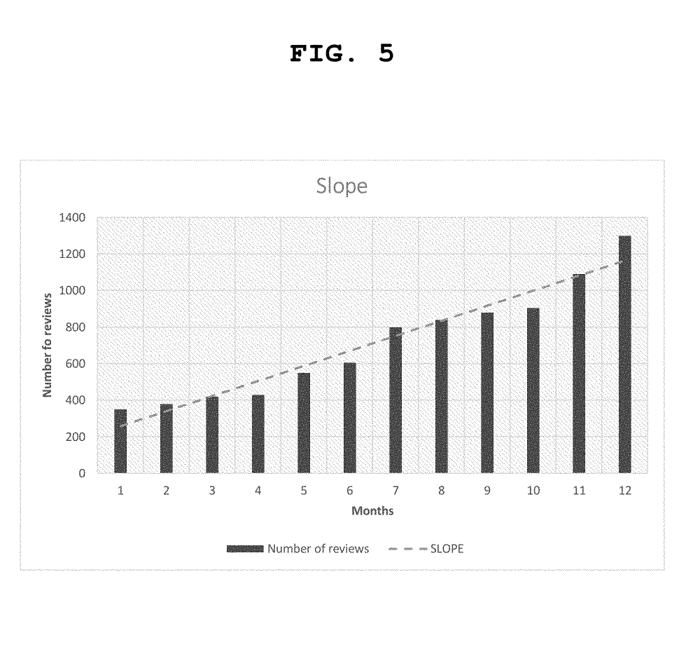

The present invention may also include measuring, retrieving, calculating, and/or storing the following additional variables: (i) feedback_30_count_n; (ii) feedback_30_count_n0; (iii) feedback_30_count_sum_6; (iv) feedback_365_90; (v) ratio_lifetime_365; (vi) ratio_lifetime_90; and (vii) slope (which is equivalent to slope count), where feedback_30_count_n is the number of reviews in one month, n months ago, feedback_30_count_n0 is the number of months with more than 0 reviews out of the last 6 months, feedback_count_sum_6 is the overall number of reviews in the last 6 months; feedback_365_90 is the ratio from the number of feedbacks in the last 365 days to the number of feedbacks of the last 90 days, ratio lifetime_365 is the ratio of all of the feedbacks in seller's lifetime to the number of feedbacks in last 365 days, ratio lifetime_90 is the ratio of all of the feedbacks in seller's lifetime to the number of feedbacks in last 90 days, and slope is the trend (i.e., angular coefficient of the linear tendency estimator) relating to the number of reviews over the last 365 days, depicted as the dotted line in FIG. 5. FIG. 1 also depicts slope as a distribution of the variation in the number of reviews. While the present embodiment utilizes time periods of 30 days, 90 days, 365 days, and seller's lifetime, this embodiment is a non-limiting example, and the present invention may utilize any other set of varied time periods in relation to the measured, retrieved, calculated, and/or stored variables.

The present invention may also include measuring, retrieving, calculating, and/or storing the following additional variables: a total number of positive customer reviews over one or more defined time periods, a total duration of the presence of the online marketplace seller in the online marketplace, a rate of change in quality (or rating) of customer reviews over one or more defined time periods, a total number of sold products over one or more defined time periods, and prices of the sold products.

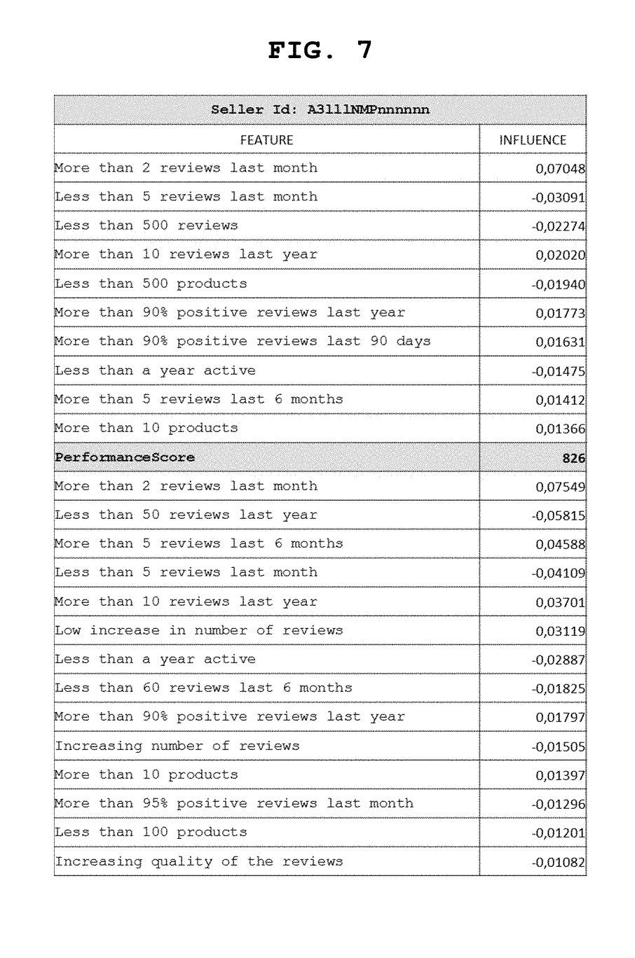

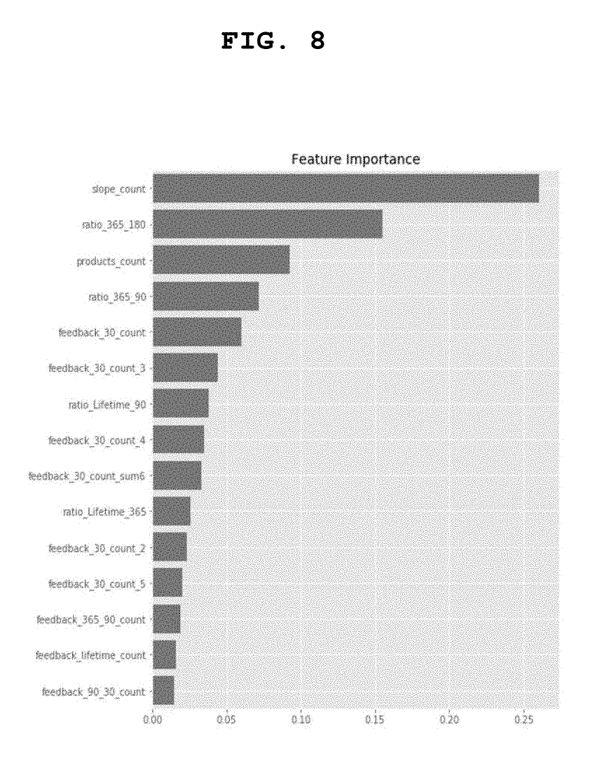

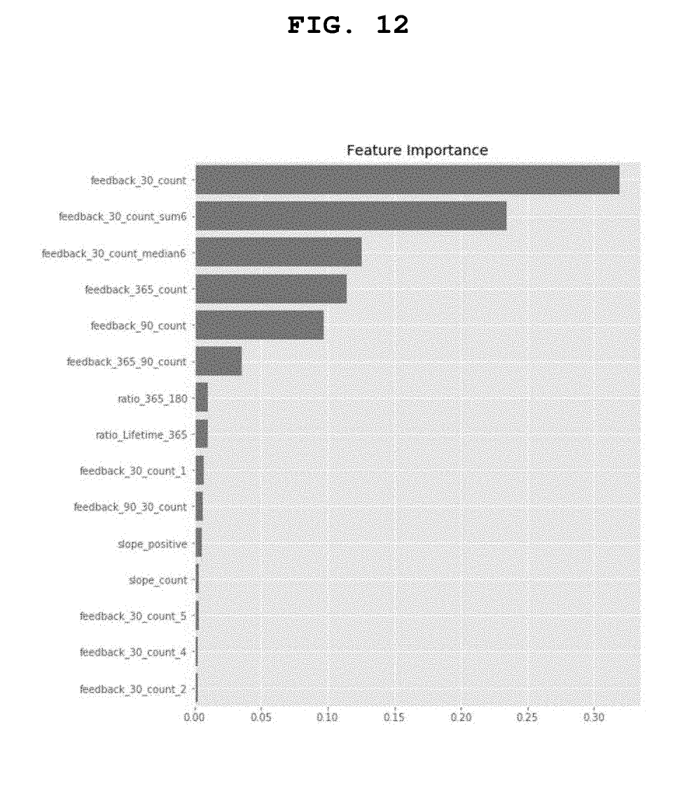

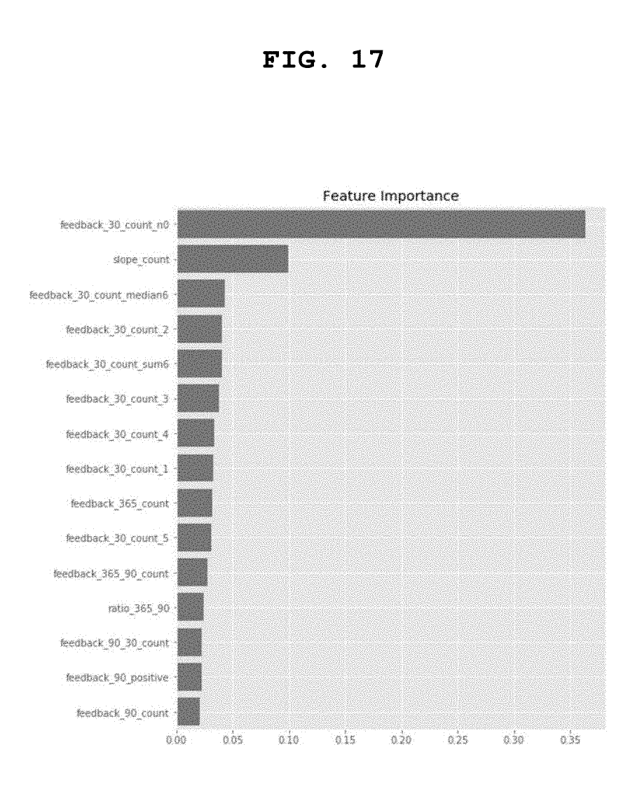

The aforementioned variables may be weighted with varying weight factors in producing an index or score of the present invention. FIGS. 7, 8, 12, and 17 depict the influence and importance of certain variables which may be utilized in the different embodiments of the present invention. To keep the ratios and variable values updated and thus more reliable, it is recommended to have access to a marketplace data collection system having continuous or near continuous updating capabilities.

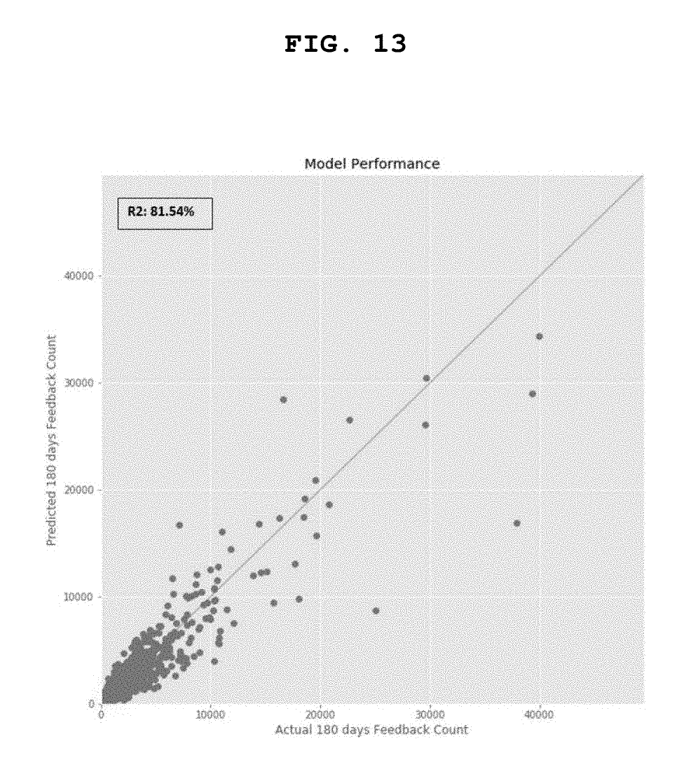

With this big data information and the calculated ratios, the present invention may observe patterns in the entire database just prior to each prediction, and build a machine learning model based on random forests to predict performance and reliability scores. The present invention may be utilized through one or more processors with executable instructions to implement the methods described herein. In one embodiment of the present invention, the forecasts are made for 90, 180, and 360 days. As the system collects and analyzes data in a continuous fashion, these ratios become more fluid, and financial distress or trends can be more easily detected. FIG. 13 shows the model performance of a 180 days feedback prediction to the actual 180 days feedback count.

Trends

The correct identification of sales trends is critical to the production of accurate reliability scores. The main sales trends used by the present invention are described below.

Sales Trends Based on Number of Reviews:

With the ratios described above, the present invention may learn to predict, using machine learning techniques, how many additional reviews a seller is going to have over a certain future timeframe, e.g., next few days or months. This prediction is a good indicator of how much a company is going to sell in the future, which is also a good proxy for its capacity for credit line repayment. An average sales price can be easily obtained by the average and median sale price of its products. Consequently, ratios between sales and number of reviews are also easily established. In one embodiment of the present invention, this ratio is found to be around 0.67%, such that for every 150 sales, one review is expected to be made, but this ratio can vary.

Sales Trends Based on Quality of Reviews:

It has been established that there is a high correlation between how much a company is going to sell (as opposed to how much it is presently selling) and the quality or trends of its reviews. Companies with a high-quality review rate, i.e., positive slope of good reviews, tend to sell in the near future at least the same volume that they are selling now. Companies with a negative slope of good reviews tend to sell less in the near future. Slopes in sales curves may be predicted based on slopes in review quality levels, particularly when based on changes over time. This prediction becomes more robust when combined with a slope analysis of the quality and quantity of social media comments about the seller. Consideration of this analysis may also be incorporated into the reliability score calculation of the present invention to make it more comprehensive.

Sales Trends Based on Benchmark:

In monitoring a group of sellers on a specific marketplace, the present invention may predict the number and quality of reviews for this group or a sample group thereof, thereby creating a moving benchmark and, therefore, improving the capacity to detect and highlight any large variations in behavior. This analysis allows for flagging sellers on both sides of the spectrum—the best performers and the highest risk companies.

Additional Information

When establishing a benchmark for sellers on each analyzed marketplace and with knowledge of the share of sales from each seller, an index may be created that shows how much each marketplace is selling. This index predicts sales from these marketplaces and analyzes their expected growth rate in comparison to other marketplaces, with the ability to account for seasonality effects. This index may be useful for both investors and sellers in this marketplace. For the investor, the index can be used to predict performance and stock prices from the seller company. To the seller, the index can be used to assist in deciding on which marketplaces to utilize, as this data can be used to sustain their decisions to channel sales to one or more appropriate marketplaces. Investors in sellers or even manufacturers may use this information to assist in the appraisal of seller valuations by a more accurate prediction of sales and results.

TABLE 3

| | Company 1 | | | | Company 2 | | | |
|---|---|---|---|---|---|---|---|---|
| Company | Count | Positive | Neutral | Bad | Count | Positive | Neutral | Bad |
| LTNR | 630,793 | 98.50% | 0.50% | 1.00% | 192,593 | 98.50% | 0.50% | 1.00% |
| 30DNR | 12,263 | 99.00% | 0.00% | 1.00% | 4,060 | 82.00% | 6.00% | 12.00% |
| 90DNR | 39,894 | 98.00% | 1.00% | 1.00% | 24,153 | 98.50% | 1.00% | 0.50% |
| 365DNR | 159,500 | 98.00% | 1.00% | 1.00% | 101,292 | 98.00% | 1.00% | 1.00% |
| 30LT | 1.94% | 100.51% | 0.00% | 100.00% | 2.11% | 83.25% | 1,200.00% | 1,200.00% |
| 3090DNR | 30.74% | 101.02% | 0.00% | 100.00% | 16.81% | 83.25% | 600.00% | 2,400.00% |
| 30365DNR | 7.69% | 101.02% | 0.00% | 100.00% | 4.01% | 83.67% | 600.00% | 1,200.00% |
| 90365DNR | 25.01% | 100.00% | 100.00% | 100.00% | 23.84% | 100.51% | 100.00% | 50.00% |
| 90LTNR | 6.32% | 99.49% | 200.00% | 100.00% | 12.54% | 100.00% | 200.00% | 50.00% |
| 365LTNR | 25.29% | 99.49% | 200.00% | 100.00% | 52.61% | 99.49% | 200.00% | 100.00% |

| | Company 3 | | | |
|---|---|---|---|---|
| Company | Count | Positive | Neutral | Bad |
| LTNR | 1,857 | 92.00% | 3.00% | 5.00% |
| 30DNR | 286 | 95.00% | 2.00% | 3.00% |
| 90DNR | 1,060 | 93.00% | 2.00% | 5.00% |
| 365DNR | 1,855 | 92.00% | 3.00% | 5.00% |
| 30LT | 15.40% | 103.26% | 66.67% | 60.00% |
| 3090DNR | 26.98% | 102.15% | 100.00% | 60.00% |
| 30365DNR | 15.42% | 103.26% | 66.67% | 60.00% |
| 90365DNR | 57.14% | 101.09% | 66.67% | 100.00% |
| 90LTNR | 57.08% | 101.09% | 66.67% | 100.00% |
| 365LTNR | 99.89% | 100.00% | 100.00% | 100.00% |

TABLE 4
Past Sales Inference

| Sales | Company 1 | Company 2 | Company 3 |
|---|---|---|---|
| Average Sales | 25.00 | 31.00 | 22.00 |
| Price ($) | | | |
| Ratio Between | 2.50% | 2.50% | 2.50% |
| Reviews/Sales | | | |
| Sales Last 30 | 12,263,000 | 5,034,400 | 251,680 |
| Days | | | |
| Sales Last 12 | 159,500,000 | 125,602,080 | 1,632,400 |
| Months | | | |
| Lifetime Sales | 630,793,000 | 238,753,320 | 1,634,160 |

In the example set forth in Tables 3 and 4, Company 3 is a much newer company (90LTNRC=57.08% and 365LNRC=99.89%), Company 2 has received a large number of bad reviews in the last 30 days (30LTB=1,200.0%) and is likely approximately 2 years old (365LNRC=52.61%). This last calculation serves as a proxy, and as more data is collected, the present invention becomes more accurate in determining the total duration of a company's presence in the marketplace. Additionally, Company 2 had a significant yet predictable, in light of the bad reviews count, decrease in sales on the last 30 days (3090DNRC=16.81%). These figures and calculations flag a higher risk on both reputation and future sales. Company 1 is more stable and larger, and has enjoyed continued levels of good customer satisfaction.

Table 5 below provides sales predictions calculated according to the above-described information.

TABLE 5
Sales Prediction

| Period | Company 1 | Company 2 | Company 3 |
|---|---|---|---|
| Next 30 Days | 12,418,007 | 3,873,412 | 3,873,412 |
| Next 90 Days | 38,495,822 | 6,972,142 | 10,458,212 |
| Next 180 Days | 78,916,434 | 10,806,819 | 21,648,500 |

One innovative feature of the present invention is the use of the number and quality of the past seller reviews to predict the seller's future sales volume. It was discovered that the variation in the number of previous reviews and the slope of this variation are important features for predicting future sales volume.

In one example, SVnm is defined as the amount of sales of a marketplace seller in the n month period prior to a given date (GD), NRVnm is defined as the increase in the number of reviews of a marketplace seller in the n month period prior to a given date (GD), DPRnm is defined as the ratio between SVnm and NRVnm, which is the sales revenue per review in the n month period prior to a given date (GD), and PRVnm is defined as the predicted increase in the number of reviews of a marketplace seller in n months after the given date (GD). The predicted accumulated sales volume in the n month period (PASVnm) after the GD can be calculated as PASVnm=PRVnm×DPRnm.

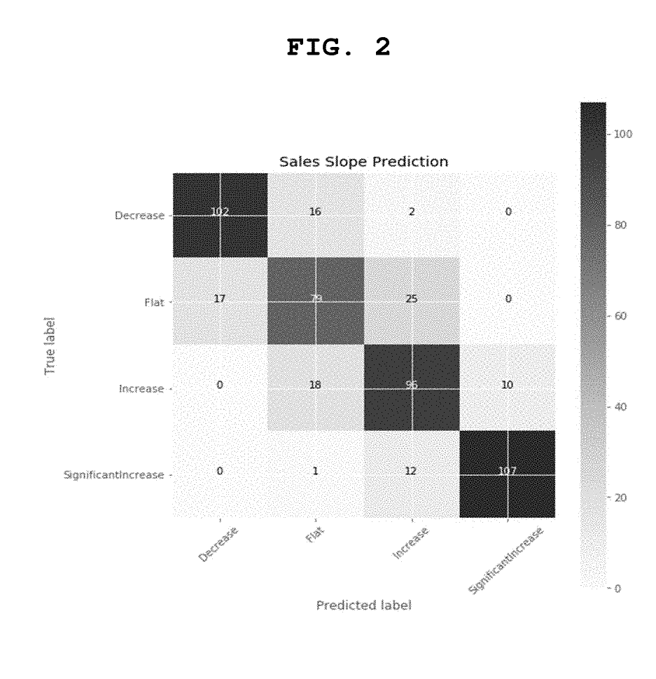

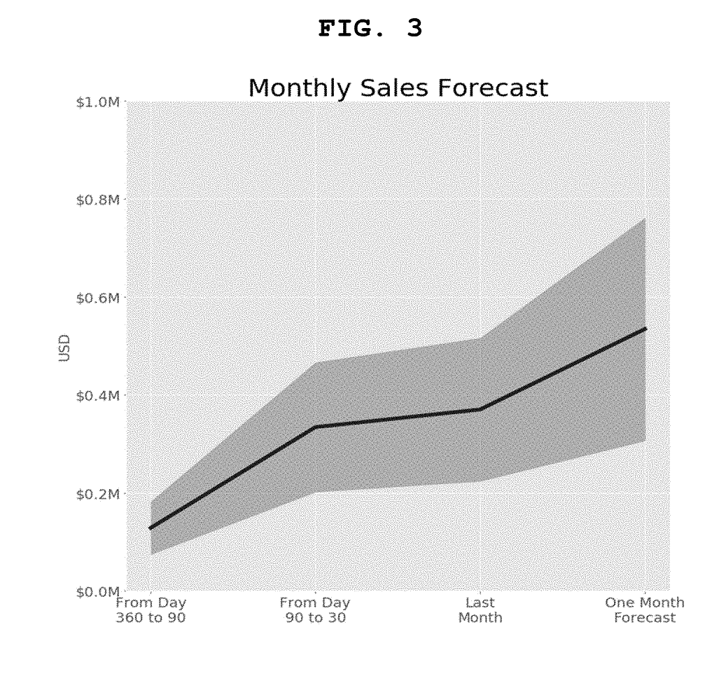

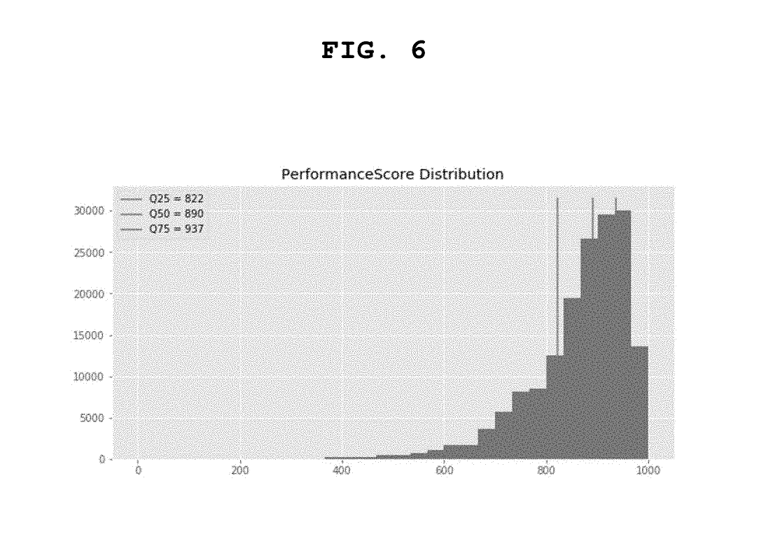

This logic and method of calculation relates to data collected in any period before the GD as well as for predictions for any period after the GD. In one embodiment of the present invention, the number and quality of the reviews in the past six months are a good parameter to predict the volume of sales for the next six months. For example, in this embodiment, to predict in July of a given year the sales volume in December of that year, the accumulated data of the number of reviews and sales volume that occurred between December of the previous year and June of that year is utilized. FIG. 2 illustrates a predictive sales plot for predicting whether a seller will increase or decrease its sales over the next six months. FIG. 3 provides an example predicting next month's sales, including estimated confidence intervals. FIG. 6 illustrates a distribution plot relating to the probability of a marketplace seller increasing its number of reviews in the next six months in comparison to a number of marketplace sellers.

By selecting each future month as the month to be predicted, the system learns to make more accurate predictions and resolve required corrections, if any, to continue improving the calculation of performance indexes and reliability indexes. Using the sum of reviews in a period of six months allows for some consideration of seasonality effects, if any. It is also possible to use the sum of reviews over different time periods.

Based on this analysis, the present invention may predict a Future Financial Performance Credit Score Index (FFPCSI) for each company as well as the expected maximum values that the company could repay per month or other set period. Matching these values with the financial cycle of the company will increase the safety of credit operations for both the seller borrowing the money and the lender providing the credit. Other important considerations include the mechanism by which the relevant company is fulfilling its orders, such as through the marketplace itself (which is more reliable), through its own fulfillment centers, through third party fulfillment centers, or a combination thereof.

Credit Limits

As opposed to the traditional credit scores available in the market, the present invention may automatically suggest an amount of money that a lender can lend to a relevant company according to some set of boundary conditions or established limits. This suggestion may be based on: (1) the predicted sales volume for the company, obtained as described above; (2) parameters inputted by the lender as an upper bound limit for the lending amount based on predicted sales volumes, financial history of the company, and the like. In embodiments of the present invention, some of the boundary conditions are: (i) 5% of the predicted annual sales volume; (ii) 17.5% of the predicted sales volume for the next 90 days; (iii) 18.5% of the predicted sales volume for the next 180 days, etc. In other embodiments of the present invention, the limit is set as a reduction factor based on the financial history between the borrower and the lender, e.g., 35% of the maximum historical lending amount. Once these factors are inputted for a given company, the present invention may present, based on the analysis presented above, the suggested maximum borrowing amount for that company, significantly reducing the effort expended in determining the amount to be lent, and thereby increasing the efficiency and security of the lender's operations.

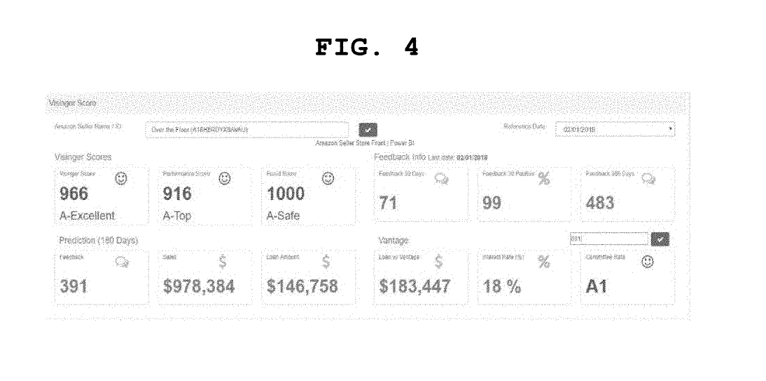

FIG. 4 provides a typical output from a system of the present invention. The output shows a performance score of 916 and reliability score of 1000. Using weights of 0.4 and 0.6, respectively, the overall score is 966. The model estimates $978k in sales for the following 180 days. Based on the credit parameters previously inputted by the lender, the borrower will be offered a line of credit in the amount of $183,000 with an 18% interest rate.

Generally, the interest rates are variable with the scores and can be inputted into the system at the beginning of system use by the seller. The interest rates can vary at the seller's discretion, affecting only future analysis. Based on the inputted information, the system can automatically suggest the interest rate. Typically, a higher score will result in a smaller suggested interest rate.

Brand Valuation

In traditional markets, brand valuation is a subjective metric that tries to evaluate a company's brand in terms of its reputation, its differentiation, and its capacity for generating results in the future. The present invention creates a reliable mechanism for brand value quantification of small- and medium-sized companies. Usually, this value is only considered with respect to a large-sized company, but even brands of smaller companies have a value, which is not easily evaluated from the tools available in the market. The general investor can use the present invention to properly evaluate e-sellers in both the AMAZON marketplace as well as other marketplaces. The basic data required by this invention are found in public records, i.e., data that is freely available to everyone in the market. Sellers in any marketplace that provides the above-described data can be analyzed with the methods of the present invention described herein. The present invention may also make use of data from non-public records or sources, e.g., data obtained through allowed access to a marketplace and its historical data. The present invention may also make use of data from both public and non-public records or sources.

The methods of the present invention permit the use of the number of reviews and trends in the perceived quality of the brands to predict future sales performance, future margins, and projected cash flow. Based on the calculated predictions of future sales, made by using the above-described methodology, and by adopting standard revenue multiples on retail segments, an objective numerical valuation may be made as a direct result of the increased analytics utilized in the present invention, improving the way in which brands are valued.

The enterprise value-to-revenue multiple (EV/R) is a measure of a company's value, calculated by taking the enterprise value of a company and dividing it by the company's revenue. To calculate the enterprise value of a company, the following formula may be used: Enterprise value=company market capitalization+total debt−cash.

The following is an example using the features of one embodiment of the present invention, where, for the sake of simplicity, the numbers have been rounded. A buyer offers $18 million to acquire a company. The company has $2 million in short-term liabilities, $3 million in long-term liabilities, and $12.5 million in assets where 10% of those assets are reported as cash. Using the above-described forecasting method, the present invention projects $8.5 million in revenue for the following year. Using this scenario, the enterprise value of the company is calculated as follows: Enterprise value=$18,000,000+($2,000,000+$3,000,000)−($12,500,000×0.1)=$21,750,000. To calculate the EV/R, simply take the enterprise value and divide it by the projected revenue for the year: EV/R=$21,750,000/$8,500,000=2.55.

### CONCLUSION

The presently-described FFPCSI for marketplace sellers may consider the total number of reviews, customer satisfaction levels, and trends to predict sales, financial distress, and significant movement in the sales and results of a seller. Through utilization of available big data and machine learning technology, the capacity for tracking and processing data in real-time is enhanced and may be used to create or update the FFPCSI.

This index encompasses both the likelihood of sudden movement and the maximum payment capacity of a relevant company, assisting lenders in understanding their clients and finding those classes of sellers that fit better with the lenders' businesses. The FFPCSI may also illuminate those industries that are booming in comparison to others, as sellers tend to limit their products to certain specific categories. Products and categories may have their own indexes as well. The index itself may be used in its general form, i.e., on scale of 1 to 1,000, or in combination with credit scores provided by traditional credit bureaus, e.g., EQUIFAX, EXPERIAN, and the like. In particular, a financial performance forecast score, a reliability score, and a credit bureau credit score may each be utilized together to produce a hybrid financial performance forecast score. The index may also suggest predicted maximum amounts and interest rates for lending. Accordingly, the present invention may include automatic production and transmission of a lending proposal from lender to seller based on this index.

The variables utilized in the present invention may be combined with different weightings such that lenders are able to create their own personalized analyses. However, the present invention is focused on measuring a seller's size, its past and future sales, and its reputational trends, and by quickly detecting swings or movements in those metrics, such that lenders will know what to expect from the borrowing company and its future behavior. Understanding the categories and products in which the sellers operate also provides important information relating to sellers, their categories/industries, and their principal products. Marketplaces may also be measured, compared, and analyzed using these general principles.

In addition to lenders, the present invention may also assist investors, investment banks, and strategic merger and acquisition seekers in making better and more technically sound investment decisions, based on more accurate sales predictions and on early identification of trends and targets.

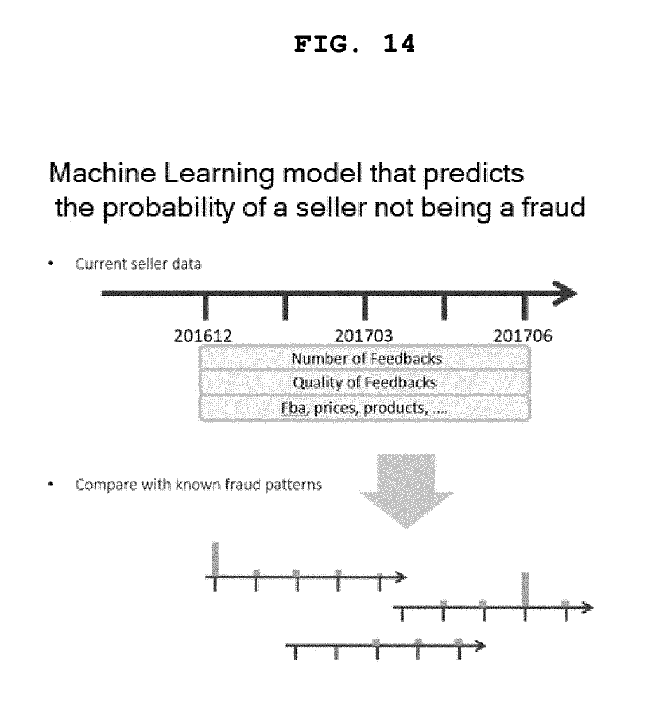

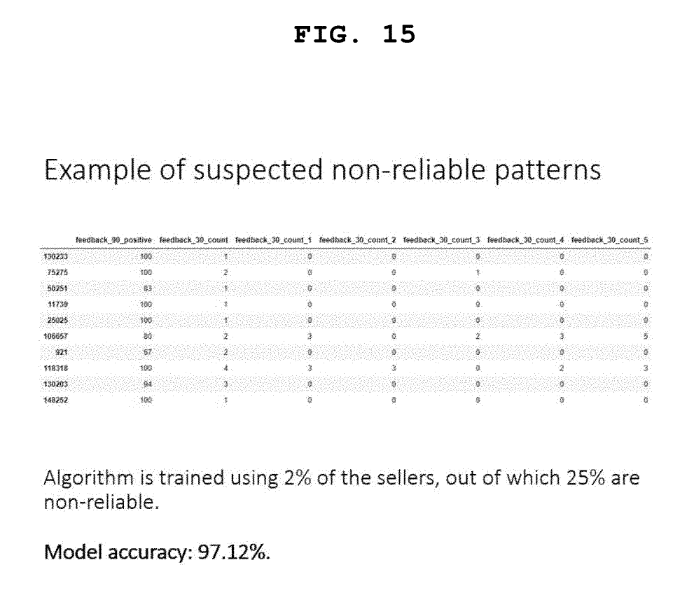

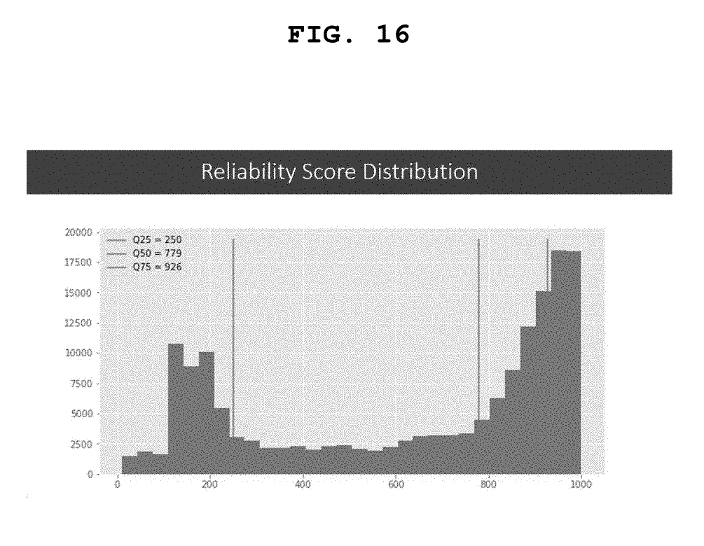

The system of the present invention can be used in tandem with a Reliability Score system to increase the effectiveness of abnormality detection through discovery of unusual movements or bias in the information provided by the marketplace about a marketplace seller. FIG. 14 illustrates a general overview of a process by which a machine learning model may be created to predict the reliability of a marketplace seller. FIG. 15 provides a sample of typical data collected from public information about sellers, such as number of feedbacks, quality of the feedbacks, offered products, and prices, that may be utilized to determine the reliability of a marketplace seller. FIG. 16 provides a distribution of a Reliability Score according to one embodiment of the present invention.

It is also possible to combine both the Performance Score and the Reliability Score to produce a single weighted score that embodies both concepts—performance and reliability. The lender may inform the system as to the appropriate weighting. In one embodiment of the present invention, the Performance Score has a weight factor of 0.4 and the Reliability Score has a weight factor of 0.6.

The embodiments and examples above are illustrative, and many variations can be introduced to them without departing from the spirit and scope of the disclosure or from the scope of the invention. For example, elements and/or features of different illustrative and exemplary embodiments herein may be combined with each other and/or substituted with each other within the scope of this disclosure. For a better understanding of the invention, its operating advantages and the specific objects attained by its uses, reference should be had to the drawings and descriptive matter, in which there is illustrated a preferred embodiment of the invention.

What is claimed is:

1. A method for using a financial performance forecast relating to an online marketplace seller, comprising:
under control of one or more processors configured with executable instructions,
collecting historical data relating to activities of the online marketplace seller, wherein the historical data comprises one or more of a total number of customer reviews over one or more defined time periods and a rating attributed to the online marketplace seller based on the customer reviews over the one or more defined time periods;
executing a machine learning component of an adaptive machine learning platform to generate a machine learning component output, wherein the machine learning component output is generated at least in part based on the historical data;
generating, based at least in part on the machine learning component output of the machine learning component, a financial performance forecast score; and
making a recommendation to provide funding to the online marketplace seller, based at least in part on the financial performance forecast score.

2. The method of claim 1, wherein the recommendation to provide funding includes a funding value and a funding interest rate.

3. The method of claim 1, wherein the recommendation to provide funding is based on parameters previously defined by a user.

4. The method of claim 1, wherein the historical data comprises one or more of a total number of customer reviews over the previous 30 days, a total number of customer reviews over the previous 90 days, a total number of customer reviews over the previous 365 days, and a total number of customer reviews over the lifetime of the online marketplace seller.

5. The method of claim 1, wherein the historical data comprises one or more of a rating attributed to the online marketplace seller based on the customer reviews over the previous 30 days, a rating attributed to the online marketplace seller based on the customer reviews over the previous 90 days, a rating attributed to the online marketplace seller based on the customer reviews over the previous 365 days, and a rating attributed to the online marketplace seller based on the customer reviews over the lifetime of the online marketplace seller.

6. The method of claim 5, wherein the historical data further comprises one or more of a total number of positive customer reviews over one or more defined time periods, a total duration of the presence of the online marketplace seller in the online marketplace, and a rate of change in quality of customer reviews over one or more defined time periods.

7. The method of claim 1, wherein the historical data comprises one or more of a total number of sold products over one or more defined time periods and prices of the sold products.

8. The method of claim 1, wherein the adaptive machine learning platform utilizes a random forest algorithm.

9. The method of claim 1, wherein the financial performance forecast score includes one or more weighted factors relating to the historical data.

10. The method of claim 1, further comprising generating, based at least in part on the financial performance forecast score and one or more of a reliability score and a credit bureau credit score, a hybrid financial performance forecast score, wherein the reliability score is a predictive value relating to the online marketplace seller being a fraudulent seller.

11. The method of claim 1, further comprising:
receiving new data relating to activities of the online marketplace seller occurring subsequent to the activities represented by the historical data, wherein the new data comprises one or more of a total number of customer reviews over one or more defined time periods and a rating attributed to the online marketplace seller based on the customer reviews over the one or more defined time periods;
executing a second machine learning component of an adaptive machine learning platform to generate a second machine learning component output, wherein the second machine learning component output is generated at least in part based on the historical data and the new data; and
generating, based at least in part on the second machine learning component output of the second machine learning component, an updated financial performance forecast score.

12. The method of claim 1, further comprising automatically producing and transmitting a lending proposal to the online marketplace seller, based at least in part on the financial performance forecast score.

13. A system configured to use a financial performance forecast relating to an online marketplace seller, comprising:
one or more processors;
one or more computer-readable media; and
one or more modules maintained on the one or more computer-readable media that, when executed by the one or more processors, cause the one or more processors to perform operations including:
collecting historical data relating to activities of the online marketplace seller, wherein the historical data comprises one or more of a total number of customer reviews over one or more defined time periods and a rating attributed to the online marketplace seller based on the customer reviews over the one or more defined time periods;
executing a machine learning component of an adaptive machine learning platform to generate a machine learning component output, wherein the machine learning component output is generated at least in part based on the historical data;
generating, based at least in part on the machine learning component output of the machine learning component, a financial performance forecast score; and
making a recommendation to provide funding to the online marketplace seller, based at least in part on the financial performance forecast score.

14. The system of claim 13, wherein the recommendation to provide funding includes a funding value and a funding interest rate.

15. The system of claim 13, wherein the recommendation to provide funding is based on parameters previously defined by a user.

16. The system of claim 13, wherein the historical data comprises one or more of a total number of customer reviews over the previous 30 days, a total number of customer reviews over the previous 90 days, a total number of customer reviews over the previous 365 days, and a total number of customer reviews over the lifetime of the online marketplace seller.

17. The system of claim 13, wherein the historical data comprises one or more of a rating attributed to the online marketplace seller based on the customer reviews over the previous 30 days, a rating attributed to the online marketplace seller based on the customer reviews over the previous 90 days, a rating attributed to the online marketplace seller based on the customer reviews over the previous 365 days, and a rating attributed to the online marketplace seller based on the customer reviews over the lifetime of the online marketplace seller.

18. The system of claim 17, wherein the historical data further comprises one or more of a total number of positive customer reviews over one or more defined time periods, a total duration of the presence of the online marketplace seller in the online marketplace, and a rate of change in quality of customer reviews over one or more defined time periods.

19. The system of claim 13, wherein the historical data comprises one or more of a total number of sold products over one or more defined time periods and prices of the sold products.

20. The system of claim 13, wherein the adaptive machine learning platform is configured to utilize a random forest algorithm.

21. The system of claim 13, wherein the financial performance forecast score includes one or more weighted factors relating to the historical data.

22. The system of claim 13, further comprising an additional operation including generating, based at least in part on the financial performance forecast score and one or more of a reliability score and a credit bureau credit score, a hybrid financial performance forecast score, wherein the reliability score is a predictive value relating to the online marketplace seller being a fraudulent seller.

23. The system of claim 13, further comprising additional operations including:
receiving new data relating to activities of the online marketplace seller occurring subsequent to the activities represented by the historical data, wherein the new data comprises one or more of a total number of customer reviews over one or more defined time periods and a rating attributed to the online marketplace seller based on the customer reviews over the one or more defined time periods;
executing a second machine learning component of an adaptive machine learning platform to generate a second machine learning component output, wherein the second machine learning component output is generated at least in part based on the historical data and the new data; and
generating, based at least in part on the second machine learning component output of the second machine learning component, an updated financial performance forecast score.

24. The system of claim 13, further comprising an additional operation including automatically producing and transmitting a lending proposal to the online marketplace seller, based at least in part on the financial performance forecast score.
